(19) United States
(12) Patent Application Publication
(10) Pub. No.: US 2018/0092382 A1
(43) Pub. Date: Apr. 5, 2018

(54) STABLE COCONUT WATER CONCENTRATE AND METHOD OF MAKING THE SAME

(71) Applicant: COCO FOUNTAIN LLC, Princeton, NJ (US)

(72) Inventors: Gert van Manen, Lawrenceville, NJ (US); Don Giampetro, Lawrenceville, NJ (US)

(73) Assignee: COCO FOUNTAIN LLC, Princeton, NJ (US)

(21) Appl. No.: 15/482,450

(22) Filed: Apr. 7, 2017

Related U.S. Application Data
(60) Provisional application No. 62/403,566, filed on Oct. 3, 2016.

(51) Int. Cl. A23L 2/56; A23L 2/02

(52) U.S. Cl. CPC A23L 2/56; A23V 2002/00; A23L 2/02

(57) ABSTRACT

The preparation of a shelf stable coconut water concentrate is described along with a method of producing a ready to drink fountain coconut water beverage from the coconut water concentrate. The resulting ready to consume fountain drink is made solely from freshly sourced or processed coconut water without adding other fruit juice, additives, enzymes, flavorings, colorings or preservatives. A coconut water stock is concentrated by an evaporation process to obtain a coconut water concentrate of at least 70°Brix having a water activity of 0.7% or below. The coconut water concentrate is microbiologically stable at room temperature without the addition of additives or preservatives, and does not require refrigeration. Water or other liquids are added to the coconut water concentrate at a ratio of between 20 to 30 parts water to 1 part stable coconut water concentrate, to form a variety of coconut water fountain drinks.

This application claims priority to U.S. provisional application 62/403,566 filed on Oct. 3, 2016 and which is incorporated by reference in its entirety.

### FIELD OF THE INVENTION

The present invention relates to a shelf stable Coconut Water Concentrate (hereinafter referred to as “CW”), and more particularly a coconut water concentrate that is free of additional other fruit juice or additional non-concentrated coconut water, additives, enzymes, flavorings, colorings or preservatives. Also provided is a process for obtaining the coconut water concentrate that is microbiologically stable at room temperature without the addition of additives or preservatives. Further, the invention provides a coconut water concentrate of at least 70°Brix with a water activity of 0.7 or below, for use in a fountain drink dispenser, which is reconstituted to the single strength coconut water for drinking.

### BACKGROUND OF THE INVENTION

Coconut water is the clear juice or liquid inside a coconut. Nutritionally, coconut water is a healthy alternative to other fruit juices because not only is it fat free, but it is also low in naturally occurring sugars. An eight ounce cup of coconut water contains approximately 10 g of natural sugar and has a caloric content of about 45 calories. Fresh coconut water contains between 300 to 400 mg of potassium (or between 6%-9% of the adult daily recommended value), approximately 40-60 mg of sodium (or between 2%-3% of daily limit) and approximately 3% and 6% of an adults recommended daily value of calcium and magnesium, respectively. Because of the abundant amount of electrolytes, coconut water is often consumed for this very reason.

Accordingly, there is a demand for a coconut water beverage, which retains the electrolytes and organoleptic properties of a fresh coconut water product, yet has the benefit of being transported at room temperature without the addition of any preservatives, additives, colorants, or combination of these known additional items. Producing fruit juices that are microbiologically shelf-stable is important to beverage manufacturers. Methods of producing coconut water concentrate (for use as an ingredient for finished juice manufacturers) that is microbiologically stable at room temperature, without the addition of additives or preservatives, while retaining its electrolyte content, translucent color and coconut water flavor, is not currently available.

### SUMMARY OF THE INVENTION

It is an object of the present invention to provide a coconut water concentrate that possess microbiological stability for storage at room temperature for at least 12 months without microbial growth. The coconut water concentrate can be, if desired, flavored with additional flavorings, such as natural or artificial fruit flavorings.

It is a further object of the present invention to produce the microbiologically shelf-stable coconut water concentrate without the use of additional fruit juices, additives, enzymes, flavorings, colorants or preservatives.

It is a further object of the present invention to provide a coconut water fountain drink, which is accomplished by adding a suitable dilution liquid/water to the stable coconut water concentrate, at a ratio of 20 to 30 parts water to one part stable 70-85°Brix coconut water concentrate, to form a single strength coconut water fountain drink that tastes similar/comparable, looks similar/comparable in terms of color and cloudiness, with no significant effect on the electrolytes and organoleptic properties when compared to coconut water that has not been previously concentrated and stored. A stable coconut water concentrate having a minimum °Brix reading of about 70 will provide a minimum ratio of 20:1 (dilution liquid:coconut water concentrate) when reconstituting the coconut water concentrate to a single strength coconut water drink. Similar nutritional claims (vitamins and minerals) for the reconstituted product, can be made as compared to the current available coconut water products on the market.

Embodiments of the invention provide a coconut water concentrate consisting essentially of a coconut water having a °Brix reading of about 70 to 85, which maintains the electrolytes and organoleptic properties of coconut water so that when the concentrate is reconstituted to a non-concentrated single strength beverage for drinking, the resulting coconut water beverage maintains similar nutritional and electrolyte composition and taste comparable to coconut water that has not been previously concentrated. The coconut water concentrate 70-85°Brix product is microbiologically stable without the need for refrigeration, addition of other fruit juice, additives, enzymes, flavorings, colorings or preservatives. By microbiologically stable, it is meant that the coconut water concentrate will not spoil even without refrigeration for upwards of 12 months.

The stable coconut water concentrate product is characterized by its translucent appearance and natural coconut water flavor and subtle coconut water aroma. The stable coconut water concentrate product is further characterized in that it can be reconstituted to single strength coconut water when used in a fountain drink dispenser.

In certain embodiments of the invention, a process of producing a coconut water concentrate consisting essentially of a coconut water having a °Brix reading of at least about 70 to 75 up to and including 85 is provided. The process is based on using a coconut water stock having a °Brix reading of about 60 and to concentrate the stock under heat and pressure to reduce the water activity of the coconut water stock to between 0.70 and 0.60 and to increase the °Brix reading to about 70 to about 85. This previous process can also be achieved in one step going from single strength coconut water at approximately 4°Brix rather than breaking this up into two parts.

In certain embodiments, a method of preparing a coconut water fountain drink is provided. In this method, a coconut water concentrate is provided which has a °Brix reading of at least about 70 and also has a 0.70 or lower water activity, and dilution liquid is provided. The coconut water fountain drink is formed by dispensing the coconut water concentrate and the dilution liquid into a cup.

### BRIEF DESCRIPTION OF THE DRAWINGS

FIG. 1 illustrates an embodiment of the invention; this depiction, however, does not limit the various steps. The first step (10) is to select a coconut water stock, which may be previously frozen with a °Brix reading of at least 60. The second step (20) is to evaporate or concentrate the coconut water stock under pressure to reduce the water activity of the coconut water stock to between 0.70 and 0.60 and the coconut water is concentrated until the °Brix reading is between 70 and 85. The third step (30) is to package the coconut water concentrate using known packaging processes.

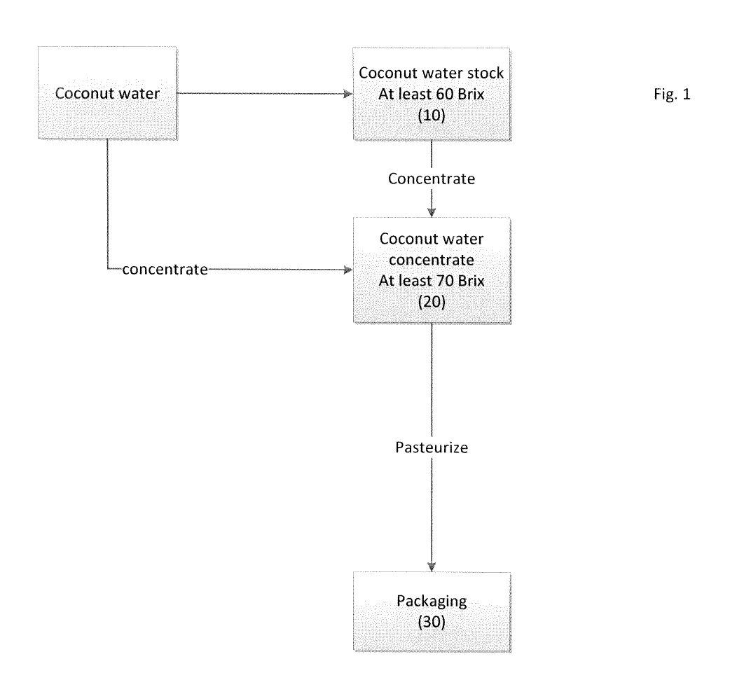

The figures are illustrative only and are not meant to limit the invention in any way.

### DETAILED DESCRIPTION

Prior to the preparation of the coconut water concentrate, coconuts have been harvested, washed, dehusked, and the coconut water obtained according to fruit juice industry standards. The coconut water is extracted employing known manual or mechanized extraction processes, followed by standard filtration processes in order to achieve a homogenous product relatively free of coconut fibers or foreign particles.

### Preparation of the Coconut Water Concentrate

As the first step, coconut water or liquid stock that was previously concentrated up to a °Brix reading of at least 50, and preferably about 60, is obtained or is prepared. In certain embodiments, the process can also be achieved in one step going from single strength coconut water at approximately 4°Brix, to between 70-85°Brix, rather than breaking this up into two parts. The coconut water stock can be previously treated by known concentration methods, including vacuum and evaporation processing. The coconut water stock is stored under frozen conditions (0° F./−18° C.), until processed.

A coconut water stock having a °Brix reading of about 50-60 is concentrated using an evaporation process involving heat and pressure to reduce the water activity of the coconut water stock to between 0.70 and 0.60 to form a coconut water concentrate (“CWC”) having a °Brix reading of at least about 70 to 85. In certain embodiments, the °Brix reading is about 75-80, 70-85, 70, 71, 72, 73, 74, 75, 76, 77, 78, 79, 80, 81, 82, 83, 84, or 85. The evaporation process can be a one, two step, three step or multi step process. In certain embodiments, an evaporation process is performed using standard evaporation and or vacuum equipment designed for such food industry applications, including the concentration of fruit juices. This evaporator equipment is utilized to reduce the water activity of the coconut water concentrate stock until the coconut water concentrate stock is further concentrated such that its water activity is below 0.7. Moreover, as the evaporation process step is performed to reduce the water activity of the coconut water stock to between 0.70 and 0.60, the °Brix readings are increased to between about 70 and 85 or 75 to 85 or about 75-80 or to 70, 71, 72, 73, 74, 75, 76, 77, 78, 79, 80, 81, 82, 83, 84, or 85.

In the next phase of the preparation of the shelf stable coconut water concentrate process, the coconut water stock is pasteurized

Pasteurization is used to reduce the microbe count and, therefore, retard spoilage, in this case, it is required as per Juice HACCP regulations. Common commercial pasteurization methods may be used to heat the coconut water concentrate until it reaches pasteurization temperature.

Coconut water concentrate produced by the process described above has a shelf life of upwards of twelve months and does not need refrigeration. Refrigeration may be used to help to maintain overall product quality over the shelf life, not safety. The CWC does not need to be aseptically prepared and put into containers and packed under aseptic conditions.

The CWC is also stable without the need for the addition of preservatives, other fruit juices, enzymes, colorings, flavorings, or other stabilizers.

The CWC can be reconstituted into a single strength and yet maintain a similar taste, look and smell, as well as contain the same electrolyte composition as a coconut water that had not been previously concentrated to at least 70-75°Brix. In fact, because of these properties, it can also be classified at 100% juice as well.

For other fruit juices in order to go to a higher °Brix such as 70 or 75, the fruit juice needs to have pulp and fibers removed, otherwise these products/fruits will burn in the evaporation process and lead to an off-putting taste and detrimental change in color. Compared to other concentrated juices, coconut water is unique in that it does not have pulp or fibers which will burn when processed to higher °Brix. Traditional juice concentrates like orange and apple burn at higher temperatures. This is not the case with coconut water. Accordingly, methods of preparing the CWC that has a °Brix reading of at least about 70 as described herein occur without the pulp or fibers being first removed.

Coconut water is unique as a juice is it is translucent color and is free of suspended solids unlike any other fruit juice. The electrolytes contained therein are not affected by heat. Also unlike other fruit juice that is consumed for vitamins and fiber, coconut water is consumed for its electrolytes. The same nutritive claims made from retail coconut water products, can be made from coconut water reconstituted from the 70-75°Brix product disclosed herein. Even when other fruit juices, after being stripped from pulp etc., are evaporated to 75°Brix like apple juice, they cannot be reconstituted to single strength apple juice that has same qualities (including look, taste and smell) as apple juice made from single strength. The resulting diluted juice tastes different and looks different.

In addition, since the single strength °Brix value for coconut water is 4.2; at 70°Brix the CWC has a unique minimum 20:1 ratio for making single strength coconut water, making it uniquely suitable for a fountain application, as most other common fountain systems work on a 5:1 or 7:1 dilution rate. In some instances the ratio may be 20:1 to 24:1. Other juices at 70°Brix, if even possible to obtain, because they have a much higher single strength °Brix value to start with, would result in a dilution rate closer to the more common 5:1 and 7:1 ratios.

Low acid foods are classified by their pH being greater than 4.6 and water activity greater than 0.85. In this coconut water concentrate of the invention, a traditional low acid food (coconut water) is processed it so that the water activity is less than 0.7, the pH is above 4.6, but its °Brix above 70 and water activity below 0.7 make it a shelf stable low acid food that does not need to be acidified.

### Preparation of a Coconut Water Drink and a Coconut Water Fountain Drink

The coconut water concentrate obtained following the process recited above is mixed with a dilution liquid, which is any suitable or desirable liquid beverage including, but not limited to, water, including plain or carbonated water, fruit juice, tea, typical soda fountain drinks, sports beverages, and the like. Preferably the CWC is reconstituted with water to make a single strength coconut water product at 4.0-4.2°Brix. In certain embodiments preparation of a fountain 100% carbonated coconut water non-acidified drink is now possible.

Natural fruit juices in fountain machines are either refrigerated or have added preservatives. In contrast, with the present invention, coconut water drinks are formed in a fountain application without the need for refrigeration of, or preservatives for the coconut water concentrate.

In particular embodiments the amount of dilution liquid added to the coconut water concentrate can be at a ratio of 15 to 30 parts liquid or water to 1 part coconut water concentrate, or more preferably, the ratio of dilution liquid is 20 to 30 parts to 1 part coconut water concentrate.

The holding reservoir which holds the CWC and/or other parts or the entire fountain drinking machine (such as, without limitation, tubing for transporting the CWC from the holding reservoir to a dispensing point) need not be refrigerated since the CWC is stable without the need for refrigeration. It may be refrigerated if desired, but it is not necessary.

The coconut water fountain drink produced by any of the methods described herein maintains the same or similar electrolyte content, appearance and taste as a coconut water that has not been previously concentrated. By similar it is meant that the properties are not noticeably different to the human palate. This simply is not achievable using other fruit juices that have been held without refrigeration and/or were concentrated.

A coconut water fountain drink utilizing a fountain drink dispenser may be produced by dispensing CWC having a °Brix reading of a least about 70 and water activity less than 0.7 into a beverage drinking container (which may be any suitable container such as a cup, mug, glass, bottle, etc.). A dilution liquid is also dispensed into the beverage drinking container to form a single strength coconut water drink.

The dispensing of the CWC and the dilution liquid can occur at the same time, or stepwise, or one after the other. The CWC can be dispensed form one line and the liquid can be dispensed from a different line to ensure that the coconut water concentrate and the dilution liquid do not come into contact with each other until dispensing.

The CWC and the dilution liquid may be partly or fully mixed in the cup, or partly or fully mixed prior to entering the cup, for example in the air or in a nozzle.

What is claimed is:

1. A stable coconut water concentrate, wherein the coconut water concentrate has a minimum °Brix reading of about 70, a water activity reading below 0.7 and the concentrate maintains the electrolytes and organoleptic properties of coconut water so that when the concentrate is diluted to a non-concentrated single strength solution for drinking, resulting coconut water maintains similar nutrition and taste as a coconut water that has not been previously concentrated.

2. The coconut water concentrate of claim 1 wherein the coconut water concentrate has a °Brix reading of about 70 to 85.

3. The coconut water concentrate of claim 1, wherein the coconut water concentrate is microbiologically stable without the need for refrigeration, addition of other fruit juice, additives, enzymes, flavorings, colorings or preservatives.

4. The coconut water concentrate of claim 1, wherein the concentrate has a water activity of below 0.7.

5. The coconut water concentrate of claim 1, wherein the concentrate can be diluted to a single strength concentrate when dispensed from a fountain drink dispenser.

6. A stable coconut water concentrate, made by the process comprising the following steps:
selecting a coconut water stock having a °Brix reading of about 60, evaporating the coconut water stock one or more times under pressure to reduce the water activity of the coconut water stock to between 0.70 and 0.60, and to increase the °Brix reading of a minimum of about 70 wherein the coconut water is the sole source of flavor of the coconut water concentrate.

7. A stable coconut water concentrate, made by the process comprising the following steps: selecting a single strength coconut water stock having a °Brix reading of about 4, evaporating the coconut water stock one or more times under pressure to reduce the water activity of the coconut water stock to between 0.70 and 0.60, and to increase the °Brix reading to a minimum of about 70, wherein the coconut water is the sole source of flavor of the coconut water concentrate.

8. A method of producing a stable coconut water drink concentrate, the method comprising the steps: selecting a single strength coconut water stock having a °Brix reading of about 4, concentrating the coconut water stock using a multi stage evaporative process involving heat and pressure to form a coconut water concentrate having a minimum °Brix reading of about 70 to form a stable coconut water drink concentrate.

9. A method of producing a stable coconut water drink concentrate, the method comprising the steps: selecting coconut water stock having a °Brix reading of about 60, concentrating the coconut water stock using an evaporative process involving heat and pressure to form a coconut water concentrate having a minimum °Brix reading of about 70 to form a stable coconut water drink concentrate.

10. A method of preparing a coconut water fountain drink, comprising the steps of:
providing a coconut water concentrate having a °Brix reading of at least about 70;
providing a dilution liquid; and
forming the coconut water fountain drink by dispensing the coconut water concentrate and the dilution liquid into a cup.

11. The method of claim 10 wherein the dilution liquid is plain water.

12. The method of claim 10 wherein the dilution liquid is carbonated water.

13. The method of claim 10 wherein the coconut water concentrate is stable without the need for refrigeration, addition of other fruit juice, additives, enzymes, coloring, flavorings or preservatives.

14. The method of claim 10 wherein when the coconut water concentrate is diluted to form the coconut water fountain drink, the resulting coconut water fountain drink maintains the same nutrition, electrolyte content, appearance and taste as a coconut water drink that had not been previously concentrated.

15. The coconut water concentrate of claim 1 further comprising an added flavoring.
